(19) United States
(12) Patent Application Publication
(10) Pub. No.: US 2017/0276076 A1
(43) Pub. Date: Sep. 28, 2017

(54) SUPERCHARGER BYPASS VALVE AND METHOD OF CONTROLLING SAME

(71) Applicant: Hamburger's Specialty Vehicles, Inc., Toms River, NJ (US)

(72) Inventors: David Goral, Bayville, NJ (US); Henry Daniecki, Cream Ridge, NJ (US); Edward Hamburger, Toms River, NJ (US)

(73) Assignee: Hamburger's Specialty Vehicles, Inc., Toms River, NJ (US)

(21) Appl. No.: 15/342,245

(22) Filed: Nov. 3, 2016

Related U.S. Application Data
(60) Provisional application No. 62/314,137, filed on Mar. 28, 2016.

(51) Int. Cl. F02D 41/00; F02M 35/10; F02D 9/10; F02B 33/38

(52) U.S. Cl. CPC F02D 41/0007; F02B 33/38; F02M 35/10157; F02M 35/1038; F02M 35/10386; F02M 35/10229; F02D 9/105

(57) ABSTRACT

A control system for a vehicular supercharger regulates the flow of a vacuum signal to a boost valve to modulate the supply of compressed air to an internal combustion engine. In one embodiment, the control system includes a solenoid that regulates the vacuum signal in response to one or more vehicle sensor signals inputted to an electronic controller.

### CROSS-REFERENCE TO RELATED APPLICATIONS

This application claims the benefit of U.S. Provisional Application No. 62/314,137, filed Mar. 28, 2016, the disclosure of which is incorporated herein by reference.

### BACKGROUND OF THE INVENTION

This invention relates in general to supercharging devices used in conjunction with internal combustion engines. In particular, this invention relates to controlling the output of the supercharging device at particular engine operating ranges.

It is well known that these types of superchargers are mechanically coupled to the engine, which spin at a speed proportional to the engine speed, creating varying levels of boost at different RPMs. However, maximum engine performance is not always desired in all operating conditions. One solution to the ill effects of constantly running a supercharger utilizes various methods to selectively bypass the compressed heated air back to the supercharger inlet or vent it to the atmosphere. This bypassing minimizes negative effects when maximum performance is not needed.

However, in the case of a centrifugal supercharger system, a typical bypass valve closes with a manifold pressure in the range of 75-90 kPa. When the bypass valve is closed and there is not a high power demand (i.e., low throttle blade angle), the air pressure in front of the throttle body (which is also the pressure on the opposite side of the blow off valve) subsequently increases until it rises enough to either crack open the blow off valve or until the compressor reaches a state of surge. Typically, the pressure is released when the blow off valve is forced open from the increased pressure and subsequently the blow off valve closes once again. This cycle of oscillating pressures at the throttle body inlet can be felt by the driver and is typically referred to as bypass valve flutter. The exact driving conditions at which the flutter and erratic drivability varies depending on factors such as, for example, the blow off valve type, internal spring pressure, supercharger size, and manifold pressure. The flutter condition can be typically felt at cruising speeds when the manifold pressure is near atmospheric.

In the case of a screw or roots type supercharger system, the existing bypass valve also closes with a manifold pressure in the range of 75-90 kPa. When in this state, this type of supercharger system currently does not allow the pressurized air to be bypassed, and the engine becomes boosted. If power demand is not at a maximum, but the existing supercharger bypass valve is closed, it is known that this situation can cause supercharger overheating and premature failure. This issue is even more apparent if a vehicle is fitted with an aftermarket camshaft (high lift, high overlap cam lobe profile) that reduces the engine's ability to create vacuum. There are many aftermarket camshafts that increase the manifold pressure (reduce the engines ability to create vacuum) to 75-85 kPa during cruising conditions which would force the existing bypass valve closed almost the entire time during a driving cycle. This greatly reduces the drivability of the vehicle and will cause excessive stress and can lead to the premature failure of the supercharger.

With either type of supercharger system, by not allowing the engine to go into boost during normal cruising speed, it will reduce fuel consumption. Typically when an engine is operating under boosted conditions, it is necessary to add extra fuel such that the air/fuel mixture is richer than stoichiometric conditions. If while cruising, the existing supercharger bypass valve is closed, the engine is being boosted and more fuel is added. By controlling the existing bypass valve and holding it open in this 75-90 kPa range when it would normally close, the engine can continue to operate under stoichiometric conditions.

U.S. Pat. No. 8,046,997 discloses a system where, in the case of a screw-driven supercharging system, there is an external spring applied to the supercharger bypass valve, biasing it in the open position. Rather than using engine manifold vacuum to open the bypass valve as in a typical configuration, the device of the '997 Patent uses the boost created from the supercharger to begin closing the bypass valve at approximately a boost pressure of 7 kPa over atmospheric, and fully closed at approximately 42 kPa over atmospheric. While this is one solution to limit boost in a screw type supercharger arrangement, it is limited to those applications where a screw type supercharger creates boost pressures well in excess of 42 kPa a majority of the time in order to be efficient. This solution also does not allow the flexibility of opening and closing the existing bypass valve at varying manifold pressures. It is fixed mechanically based on the springs used in the valve. In addition to that, many supercharger kits will rarely utilize a boost pressure above 42 kPa under normal driving conditions. Thus, it would be desirable to provide a bypass valve arrangement that provides greater control over a broader engine vacuum range.

### SUMMARY OF THE INVENTION

This invention relates in general to supercharging devices used in conjunction with internal combustion engines. In particular, this invention relates to controlling the output of the supercharging device at particular engine operating ranges. In one aspect of the invention, an improved functioning and external controlling of existing supercharger bypass valves is disclosed. In yet another aspect of the invention, the control structure and method can be utilized with supercharger bypass valves (anti-surge valves) typically used in centrifugal style superchargers as well as roots and screw type superchargers.

The electronic bypass valve controller (EBVC) is a device that controls the operation of the existing supercharger's vacuum actuated bypass valve (on either a centrifugal, roots, or screw type supercharger) utilizing input signals from one or multiple vehicle sensors, and processing them via a microcontroller to allow opening or closing of the existing supercharger bypass valve. The ability to control the existing supercharger bypass valve helps greatly improve the drivability of the vehicle when the engine is operating in a low vacuum state (near atmospheric conditions). This is due to its ability to keep the existing supercharger bypass valve open in a low vacuum, no vacuum, or low boosted state which greatly reduces both compressor surge and bypass valve flutter which would normally occur without this control. This device is used in conjunction with the existing supercharger bypass valve which is typically found on all supercharged vehicles. With the ability to process engine running conditions and driver demand in real time, the EBVC can determine if the bypass valve should be open or closed and perform the appropriate action.

The invention addresses the issues arising from a typical existing supercharger bypass valve closing near atmospheric pressure on a centrifugal, roots, or screw type supercharger setup. By utilizing one or more electrical sensor inputs from the vehicle such as, for example but not limited to, a Manifold Absolute Pressure (MAP), throttle position, pedal position, etc., an inexpensive microcontroller can process these signals and determine whether or not the existing supercharger bypass valve should be opened or closed based on the programmed parameters. In a typical supercharger application the actual opening or closing of the existing valve is done utilizing engine vacuum or pressure plumbed to one side of the blow off valve diaphragm.

The invention is plumbed in or fitted between the engine and the existing blow off valve and acts as a controllable gate to allow the manifold pressure (or vacuum) to physically close or open the valve. The benefit of the controllable gate is that vacuum can be trapped and stored to hold open the bypass valve even when the engine is operating near, at, or even above atmospheric pressure where it would normally close. The stored vacuum comes from the engine or from an alternate vacuum source and commanding the gate to open during a running condition when vacuum is present and then closing it to store it. This is not possible with a standard supercharger bypass valve alone as its operation is linked to manifold pressure. In addition, the EBVC can be programmed to open or close at any manifold pressure level desired (with other inputs limiting its function as desired) which also makes its implementation easy and widely adaptable to any supercharged vehicle application.

Another embodiment of the invention can integrate the solenoid control and the blow off valve together so the blow off valve operation can be directly controlled by the solenoid, rather than using the solenoid as a gate in the vacuum line that holds the blow off valve open. This is advantageous in that the blow off valve operation can be completely independent from the engine running conditions and the microcontroller can command the blow off valve to open or closed at any desired time or in any situation. This type of setup would also create a form of engine boost control as the solenoid can be commanded to open the blow off valve in a situation where boost limiting is desired such as in a traction control event.

Since the invention utilizes the vehicle's manifold pressure in its control algorithm (by using the vehicle's existing MAP sensor signal or a secondary absolute pressure sensor), the microcontroller can also output this parameter to the driver utilizing a display mounted inside the vehicle. As an example, the display can be a gauge, an LCD or LED display that is mounted such that the driver can easily view and monitor this value. In a supercharged vehicle, typically the driver wants to know the boost (or vacuum) in the engine, and a common practice is to install a boost gauge. This would no longer be necessary as the current invention would include this feature.

Due to the diverse range of vehicle applications that the device can be utilized on, the invention further contemplates a simple and easy method of changing calibrations. One approach is to utilize a simple tactile switch to change modes or modify microcontroller parameters. Another is to use a type of knob to change calibrations or modes. A third is to utilize inexpensive Bluetooth capabilities and make calibration changes via a downloadable application on the driver's phone or computer. The latter option allows the most flexibility. With this option, all the data the microcontroller processes could also be viewed on the user's phone or computer in real time.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of a supercharger control system for a centrifugal-type supercharger compressor, according to an embodiment of the invention.

FIG. 2 is a schematic illustration of a supercharger control system for a Roots-type or screw-type supercharger compressor, according to another embodiment of the invention.

### DETAILED DESCRIPTION OF THE PREFERRED EMBODIMENT

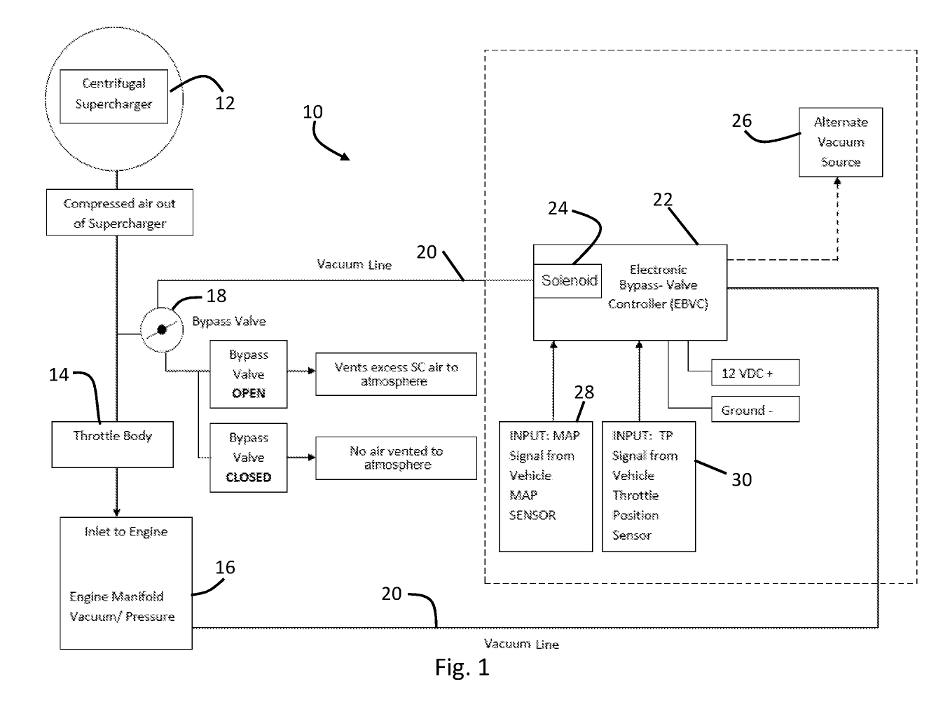

Referring now to the drawings, there is illustrated in FIG. 1 an embodiment of a supercharger control system for a centrifugal-type supercharger compressor, shown generally at 10. The supercharger control system 10 regulates the operation of a centrifugal-type supercharger 12, which is of conventional construction and is generally known in the art. As shown in FIG. 1, the supercharger 12 outputs compressed air to a control valve, such as a throttle body 14, mounted on an intake manifold 16 of an internal combustion engine. The throttle body 14 regulates air flow into the engine. Alternatively, the throttle body 14 may include a fuel delivery function, such as a fuel injection throttle body, or may be configured as a carburetor. A bypass valve 18 is in fluid communication with the flow of air between the supercharger 12 and the throttle body 14. A vacuum line 20 connects the bypass valve 18 to an Electronic Bypass-Valve Controller (EBVC) 22 to control actuation of the bypass valve 18. The EBVC 22 is operatively connected to a solenoid 24, which may be an integral component of the controller 22 or may be remotely located. The solenoid 24 is also connected to a vacuum source, which may be the intake manifold 16 or an external vacuum source 26.

The EBVC 22 is connected to one or more input signal sources and receives related input signals to determine engine operation conditions. Examples of the various types of input signals to the EBVC 22 may be a vacuum signal from the engine manifold vacuum line 20, a manifold absolute pressure (MAP) sensor 28, and a throttle position sensor 30. Alternatively or in addition to these sensor inputs, other sensors may include one or more of a pedal position sensor, a Mass Air Flow sensor, an engine RPM sensor, an air temperature sensor, a gear selector sensor, fuel pressure sensor, and an oxygen sensor. The EBVC 22 determines the proper engine conditions to admit or reject boost from the supercharger 12 and operates the solenoid accordingly.

The solenoid 24 is moved between an open state and a closed state by the EBVC 22. In the open state, the solenoid 24 permits vacuum from the vacuum source to act upon the bypass valve 18 to open or close the valve 18 in response to the vacuum signal from the vacuum source, such as the engine manifold. In the closed state, the solenoid 24 holds a particular vacuum or pressure level which may hold the bypass valve 18 in an open or closed position. The vacuum level that initiates and maintains the closed state of the solenoid 24 is determined by the EBVC 22. In certain operating conditions, the solenoid 24 maintains a vacuum level sufficient to hold the bypass valve open regardless of the vacuum or pressure state within the manifold or alternate vacuum source. In an alternate embodiment, the solenoid 24 may directly control actuation operation of the bypass valve 18. In such an embodiment, the vacuum signal may be an additional input to the EBVC 22 or may be omitted altogether.

In one embodiment, the operation of the supercharger control system 10 may be characterized in the following steps. When an ignition switch is turned on, the solenoid 24 is moved to the open state by the EBVC 22 in response to the initial key-on signal. Once the engine is running, vacuum is created by the engine within the manifold 16 and is measured by the MAP sensor 28. When vacuum sufficient to hold the bypass valve 18 open is detected, the solenoid 24 is moved to the closed state by the EBVC 22. This maintains vacuum to the bypass valve 18, keeping the bypass valve open. In one programmed operating sequence, the solenoid 24 may not open again until the MAP sensor 28 reads a value equal to or above a programmed value inputted to the EBVC 22. The EBVC 22 may be programmed to react to an open state value based on specific engine and powertrain designs as stated above. The electronic solenoid 12 may be moved to the closed state when sufficient vacuum is created to hold the bypass valve 18 open. The effect of permitting the EBCV 22 and the solenoid 24 to control the bypass valve position based on engine data, rather than on direct vacuum levels is the elimination of bypass valve flutter and boost during part throttle driving when engine vacuum is reduced to a level that can no longer hold the bypass valve open (which may particularly observed on full size trucks and SUVs when supercharged). The result is improved partial throttle drivability and increased fuel economy.

In another aspect of the invention, an illuminated LED indicator button, not shown, may be mounted in the driver cockpit. The button may function as both an indicator to the driver of the unit functioning properly, as well as gives the user the ability to change the operating parameters. The LED may illuminate when the solenoid is open, and may be off when the solenoid is closed. In addition, the LED may flash, such as on and off in 0.5 second intervals, to indicate an operational warning, such as if the MAP signal voltage is below 0.1V and above 4.9V. This may indicate a problem with the signal input to the unit

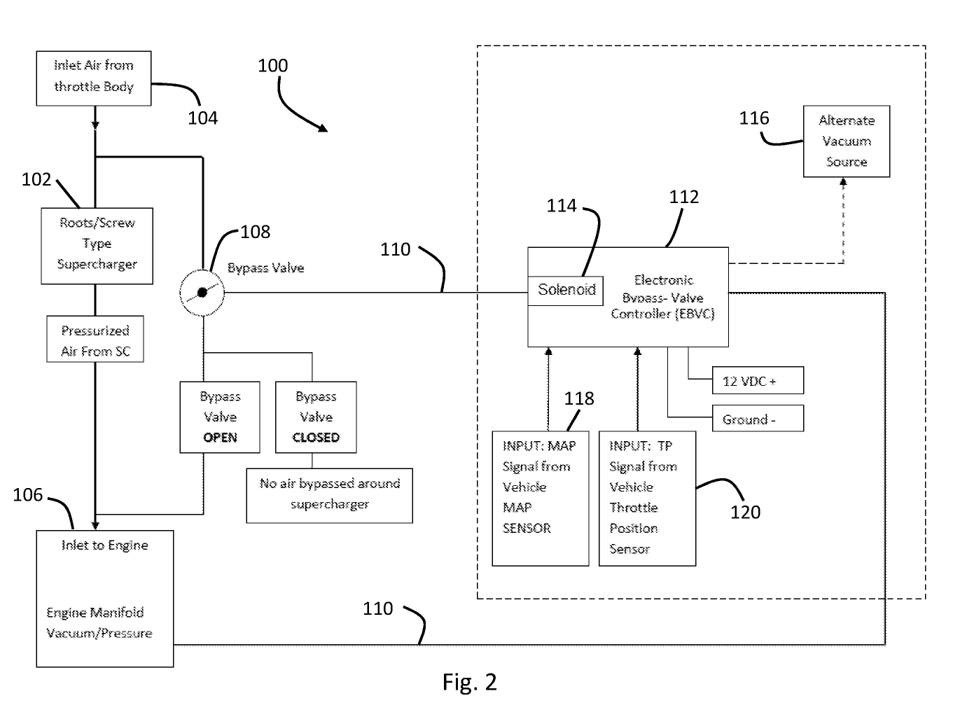

Referring now to FIG. 2, there is illustrated, an embodiment of a supercharger control system for a Roots-type or screw-type supercharger compressor, shown generally at 100. The supercharger control system 100 regulates the operation of a Roots-type or screw-type supercharger 102, which is of conventional construction and is generally known in the art. As shown in FIG. 2, a throttle body 104 supplies and regulates air flow to the supercharger 102, which in turn outputs compressed air to an internal combustion engine 106. Alternatively, the throttle body 104 may include a fuel delivery function, such as a fuel injection throttle body, or may be configured as a carburetor. A bypass valve 108 is in fluid communication with the flow of air between the throttle body 104 and the supercharger 102. A vacuum line 110 connects the bypass valve 108 to an Electronic Bypass-Valve Controller (EBVC) 112 to control actuation of the bypass valve 108. The EBVC 112 is operatively connected to a solenoid 114, which may be an integral component of the controller 112 or may be remotely located. The solenoid 114 is also connected to a vacuum source, which may be the intake manifold of the internal combustion engine 106 or an external vacuum source 116.

The EBVC 112 is similar to the EBCV 22, described above and shares the same range of input signals from sensors, such as a MAP sensor 118 or a throttle position sensor 120, and output functions to the solenoid 114. The EBVC 112 is programmed to work with the somewhat different operational characteristics of the Roots-type or screw-type supercharging units as compared to the centrifugal supercharger system, described above.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicular supercharger system comprising:
a compressor configured to boost flow of air to one or more cylinders of an internal combustion engine;
a bypass valve configured to be actuated between an opened state wherein the boosted flow of air is diverted from the one or more cylinders and a closed state wherein the boosted flow of air is delivered to the one or more cylinders; and
an electronic bypass valve controller operatively connected to the boost valve and configured to selectively control the bypass valve in response to a signal from one or more vehicular sensors.

3. The vehicular supercharger system of claim 1 wherein the compressor is one of a centrifugal, a Roots-type, and a screw-type compressor.

4. The vehicular supercharger system of claim 1 wherein the signal from the one or more vehicular sensors is associated with a measured induction system parameter.

5. The vehicular supercharger system of claim 1 wherein the one or more vehicular sensors is one or more of a manifold absolute pressure (MAP) sensor, a throttle position sensor, a pedal position sensor, a Mass Air Flow sensor, an engine RPM sensor, an air temperature sensor, a gear selector sensor, fuel pressure sensor, and an oxygen sensor.

6. The vehicular supercharger system of claim 2 wherein the compressor is a centrifugal compressor and the bypass valve diverts the boosted flow of air to atmosphere when operating in the opened state.

7. The vehicular supercharger system of claim 2 wherein the compressor is one of a Roots-type and a screw-type compressor and wherein the bypass valve diverts the boosted flow of air around the compressor when operating in the opened state.

8. The vehicular supercharger system of claim 1 wherein the electronic bypass valve controller operates a solenoid that controls actuation of the bypass valve between the opened state and the closed state in response to the signal from the one or more vehicular sensors.

9. The vehicular supercharger system of claim 8 wherein the solenoid controls output of a vacuum source to the bypass valve, such that when the solenoid is in an opened state, the bypass valve reacts to the vacuum provided by the vacuum source and when the solenoid is in a closed state, the bypass valve remains in one of an opened state or a closed state independent of the vacuum signal from the vacuum source.

10. The vehicular supercharger system of claim 9 wherein the vacuum source is an intake manifold.

11. The vehicular supercharger system of claim 9 wherein the vacuum source is a vacuum pump.

12. A supercharger control system comprising:
an electric solenoid configured to control a vacuum signal directed to a bypass valve of a supercharger; and
an electronic bypass valve controller configured to selectively control the solenoid in response to a signal from signal from one or more vehicular sensors, the solenoid being actuated between an opened state where the bypass valve reacts to the vacuum signal and a closed state where the bypass valve remains in one of an opened state or a closed state independent of the vacuum signal from the vacuum source.

13. The supercharger control system of claim 12 wherein the signal from one or more vehicular sensors is a signal from one of a MAP sensor and a throttle position sensor.

14. The supercharger control system of claim 13 wherein the electronic bypass controller includes a control algorithm, the control algorithm being programmable to define a threshold value of the signal from one or more vehicular sensors to move the solenoid between one of the opened and closed state to the other state.
